(19) United States
(12) Patent Application Publication
(10) Pub. No.: US 2003/0020400 A1
(43) Pub. Date: Jan. 30, 2003

(54) Display module

(76) Inventors: Chen-Lun Hsing Chen, Taipei Hsien (TW); Po-Hsien Lee, Taipei Hsien (TW); I-Hsiang Li, Taipei Hsien (TW)

Correspondence Address: Rabin & Champagne, P.C., Suite 500, 1101 14th Street, N.W., Washington, DC, 20005, US

(21) Appl. No.: 09/910,762

(22) Filed: Jul. 24, 2001

(51) Int. Cl. H01J 1/62; H01J 63/04

(52) U.S. Cl. 313/512; 313/498

(57) ABSTRACT

A display module comprises a plurality of light emitting elements, a metal plate, a circuit board and a display panel. The light emitting elements and the circuit board are arranged on the metal plate, and the light emitting elements are wire bonded to the circuit board. A lens is formed atop the light emitting element. The metal plate is arranged with the light emitting elements and the circuit board is positioned on lateral side or around the display panel. The metal plate provides excellent heat-dissipation effect and the light emitting elements can emit more uniform light.

### FIELD OF THE INVENTION

The present invention relates to a display module, especially to a display module with excellent heat-dissipation effect and more uniform light.

### BACKGROUND OF THE INVENTION

The light emitting diodes (LED)are extensively used in indication and illumination application. The LEDs are generally made of direct-bandgap material with two electrodes. The electrical power is applied through the electrodes to generate electron and hole pair. The electron and hole pair is recombined to emit light. The LED can be roughly classified to visible light LED and infrared LED according to the emitting wavelength thereof. The LEDs have salient properties over the conventional light bulb such as compact volume, lower power consumption, lower thermal radiation and long life. Therefore, the LEDs are extensively used in indication usage in place of light bulb.

Moreover, as the advent and maturity of high brightness LED, the application of LEDs is broadened to compass bulletin board. The high brightness LEDs have the advantages of broad view angle, stable picture, easy assembling and thin thickness. The full color high brightness LED is realized as the high brightness LEDs of three primitive colors are successfully developed.

FIG. 1 shows the sectional view of prior art LED display panel. The LEDs 11a are arranged in 3×3, 4×4, or 4×8 array and assembled to a display module 1a. A plurality of display modules la are assembled to a larger display panel. The LEDs 11a are packaged by epoxy resin and soldered to a printed circuit board 12a. Afterward, the LEDs 11a are arranged within a shade 13a formed by mold ejection and are retained by filling resin 14a. The shade 13a provides a sun blind 131a for the LEDs 11a.

However, the display module la has not satisfactory heat dissipation effect such that the heat caused by insolation or driving of the LEDs cannot be easily dissipated. The performance of the display module 1a is degraded.

### SUMMARY OF THE INVENTION

It is the object of the present invention to provide a display module with excellent heat-dissipation effect and more uniform light.

To achieve above object, the present invention provides a display module comprising a plurality of light emitting elements, a metal plate, a circuit board and a display panel. The light emitting elements and the circuit board are arranged on the metal plate, and the light emitting elements are wire bonded to the circuit board. A lens is formed atop the light emitting element. The metal plate is arranged with the light emitting elements and the circuit board is positioned on lateral side or around the display panel. The metal plate provides excellent heat-dissipation effect and the light emitting elements can emit more uniform light.

The various objects and advantages of the present invention will be more readily understood from the following detailed description when read in conjunction with the appended drawing, in which:

### BRIEF DESCRIPTION OF DRAWING

FIG. 1 shows the sectional view of prior art LED display panel;

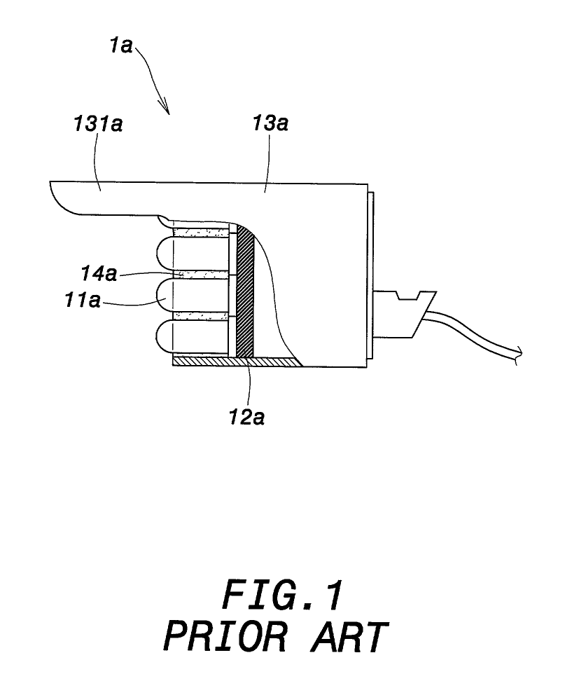

FIG. 2 shows the sectional view of the present invention; and

FIG. 3 shows the perspective view of the present invention.

### DETAILED DESCRIPTION OF THE INVENTION

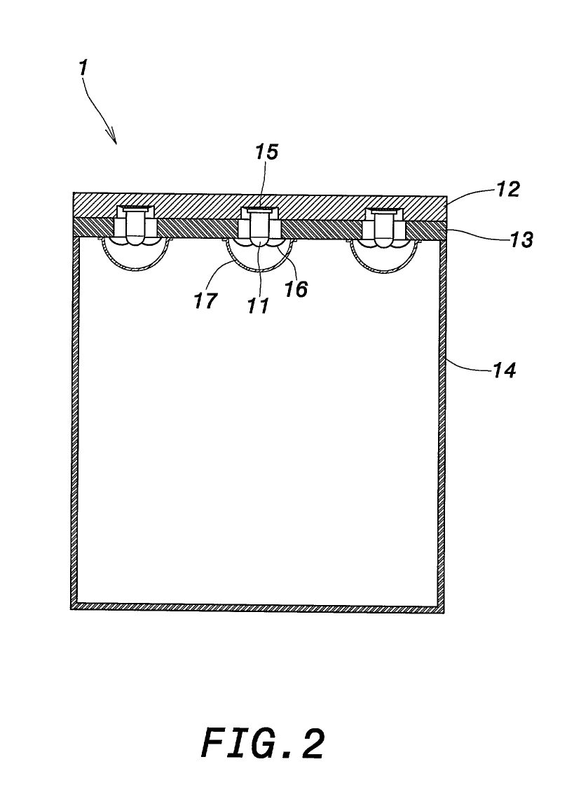

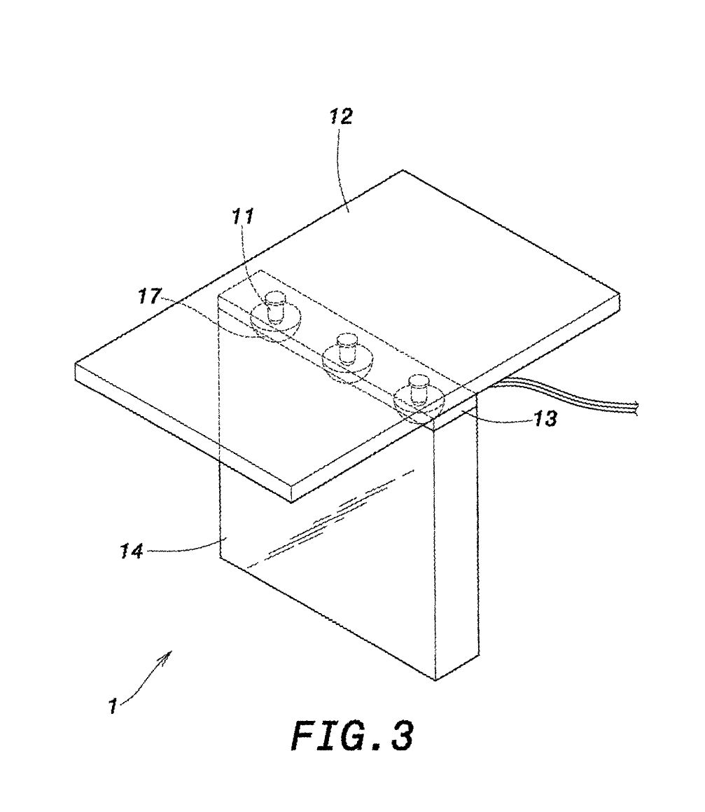

With reference now to FIGS. 2 and 3, the present invention provides a display module 1 composed of a plurality of light emitting elements 11, a metal plate 12, a circuit board 13 and a display panel 14. The light emitting elements 11 are pasted in a row to the metal plate 12 by insulative thermal glue 15. The light emitting elements 11, for example, can be LEDs and wire bonded to the circuit board 13 by conductive wire 16 such that the LEDs are electrically connected to copper trace on the circuit board. Afterward, the wire bonded LED is encapsulated by epoxy material to form a lens 17 thereon. As shown in FIG. 3, the light emitting elements 11 in a row are arranged on lateral side or around the display panel 14. The display panel 14 can be made of acrylic or polyethylene material and be of rectangular or circular shape and adhesive tapes (not shown) are pasted to the backside and lateral sides thereof. The adhesive tapes are of black or white acrylic material to block light or reflect light. A plurality of display modules 1 are assembled into a larger display panel.

The light from the light emitting elements 11 uniformly impinge into the display panel 14 for display graphic or text on the display panel 14. The metal plate 12 is used for sunproof function and dissipating the heat of the light emitting elements 11.

Moreover, the light emitting elements 11 can be of same color or different color such that the light emitting elements 11 have better color mixing effect than conventional LEDs. Moreover, the light emitting elements 11 form non-granular light dot, which is suitable for both near- and far-distance display.

In the present invention, the metal plate 12 provides excellent heat-dissipation effect to facilitate the light emitting elements 11 being operated at large current. The light emitting elements 11 can emit more uniform light and the display panel 14 can also uniform the light.

To sum up, the LED display module according to the present invention has following advantages:

(1). The LEDs are directly bound to the metal plate, thus having excellent heat-dissipation effect.

(2). The metal plate also has sunproof function.

(3). The LED display module has satisfactory color-mixing effect.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A display module comprising a plurality of light emitting elements, a metal plate, a circuit board and a display panel,
the light emitting elements and the circuit board being arranged on the metal plate, and the light emitting elements being wire bonded to the circuit board and a lens being formed atop the light emitting element,
the metal plate being arranged with the light emitting elements and the circuit board being positioned on lateral side or around the display panel.

2. The display module as in claim 1, wherein the light emitting element is LED.

3. The display module as in claim 1, wherein the light emitting elements are pasted to the metal plate.

4. The display module as in claim 1, wherein the light emitting elements emit light with same color or different colors.

5. The display module as in claim 1, wherein the display panel is of any shape, such as rectangular shape or circular shape, etc.

6. The display module as in claim 1, wherein the display panel is coated with lacquer or pasted with light-blocking or light-reflecting tape on circumference or backside thereof.
